(19) United States
(12) Patent Application Publication
(10) Pub. No.: US 2015/0332147 A1
(43) Pub. Date: Nov. 19, 2015

(54) Technique For Determining The Root Cause Of Web Site Performance Or Availability Problems

(71) Applicant: Compuware Corporation, Detroit, MI (US)

(72) Inventors: Paul Anastas, Needham, MA (US); Brian Doyle, Cranston, RI (US); Paul Wilson, Chelmsford, MA (US); Boris Zibitsker, Wilmette, IL (US); Alexander Lupersolsky, Buffalo Grove, IL (US)

(73) Assignee: Compuware Corporation, Detroit, MI (US)

(21) Appl. No.: 14/281,107

(22) Filed: May 19, 2014

(51) Int. Cl. G06N 5/04

(52) U.S. Cl. CPC G06N 5/04

(57) ABSTRACT

Automated techniques are provided for determining root causes of web site performance or availability problems. Performance metrics falling within a data analysis window are evaluated by a performance monitoring tool, where the performance metrics pertain to the loading of a web page. From the data analysis, particular problems may be surfaced for further consideration. Root causes are also determined for the surfaced problems and published by the performance monitoring tool.

### FIELD

The present disclosure relates to application performance monitoring and more particularly to techniques for determining the root cause of web site performance or availability problems.

### BACKGROUND

Companies that have distributed or Web-based applications often have a variety of tools that collect data about the performance of these applications. Specifically, tools are used to measure the end-user response time of the applications, along with multiple metrics on the web servers, application servers, databases, and the physical servers that host the applications or application components. Metric data collected includes CPU utilization, disk I/O rates, TCP transmission errors, etc. The challenge is that given an application performance problem perceived (or potentially perceived) by a user of an application, how can the cause of the problem be quickly identified given the potentially overwhelming amount of metric data that has been collected.

Performance management tools generally provide reports on the metrics being collected, but they do not automatically show the software services, metrics, hardware devices and other computing infrastructure related to the application experiencing a particular problem. The user is forced to manually sift through volumes of data with the required a prior knowledge of how the applications and services are related.

In some instances, performance management tools are able to sift through large amounts of data and identify abnormalities. Reports can then be generated regarding the abnormalities. Very little automated assistance is provided, however, to determine the underlying cause of a problem. To be effective using such performance management tools, the user must be knowledgeable about the interrelations between the applications and services, the underlying computing infrastructure as well as the features of the tool itself. Therefore, there is a need for automated techniques for determining the root cause of web site performance or availability problems.

This section provides background information related to the present disclosure which is not necessarily prior art.

### SUMMARY

This section provides a general summary of the disclosure, and is not a comprehensive disclosure of its full scope or all of its features.

Automated techniques are provided for determining root causes of web site performance or availability problems. Performance metrics falling within a data analysis window are evaluated by a performance monitoring tool, where the performance metrics pertain to the loading of a web page. From the data analysis, particular problems may be surfaced for further consideration. Root causes are also determined for the surfaced problems and published by the performance monitoring tool.

In one aspect of this disclosure, a method is presented for determining root causes of performance problems identified from one or more unsuccessful loading of web pages. The method includes: receiving a plurality of test result records, where each of the test result records falls within a data analysis window and pertains to loading of a web page during execution of a test; identifying one or more of the test result records which indicate an unsuccessful loading of the web page; for each of the identified test result records, classifying an error associated with the identified test result record into one of a group of error types; for each error category in the group of error types, totaling occurrences of the error type during the data analysis window; raising an availability problem for a given error type when the number of occurrences for the given error type exceeds a threshold, where the availability problem has at least one performance metric indicative thereof; determining a root cause for the availability problem; and publishing the root causes for the identified type of problems.

In another aspect of this disclosure, a method is presented for determining root causes of performance problems associated with successful loading of web pages. The method includes: receiving a plurality of test result records, where each of the test result records fall within a data analysis window and pertain to loading of a web page during execution of a test; identifying one or more of the test result records which indicate a successful loading of the web page; identifying a particular web page from each of the identified test result records; for each particular web page, computing a measure of variance amongst values of a performance metric, where the performance metric pertains to the loading of the web page; raising a performance problem when the variance measure exceeds a threshold; determining a root cause for the performance problem; and publishing the root cause for the identified type of problem.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram depicting an example performance management tool;

FIG. 2 is a diagram depicting a data analysis function for determining root causes of performance problems experienced in a distributed computing environment;

FIG. 3 is a flowchart illustrating an example method for identifying performance problems;

FIG. 4 is a diagram depicting an example data analysis window;

FIG. 5 is a diagram depicting an example method for further processing of page level records;

FIG. 6 is a diagram illustrating how static decision tree rules are applied to determine the most significant problems;

FIG. 7 illustrates an example user interface presenting a list of raised problems;

FIG. 8 is a flowchart depicting an example method for determining a root cause for a raised problem;

FIGS. 9A and 9B are flowcharts depicting an evaluation routine for timeout errors and byte limit exceeded errors, respectively; and

FIG. 10 illustrate an example user interface presenting a listing of root causes associated with a particular problem.

Corresponding reference numerals indicate corresponding parts throughout the several views of the drawings.

### DETAILED DESCRIPTION

Example embodiments will now be described more fully with reference to the accompanying drawings. Embodiments disclosed herein provide an agent, such as a software process, that executes remotely from a web site and is operable to measure performance and operability of the web site. The agent obtains a script that contains transactions to perform on a web site. The script executes, and requests web pages on the web site. The agent obtains the performance metrics upon occurrence of a capture event, such as an error on the web page. The capture event can be a threshold specified by a user or it can be a web page error, such as a ‘page not found’ server error. In response to the capture event, the agent captures the content of the web page on which the error occurred, and packages the content into a container such that the captured web page can be reached locally. Copies of all remote objects referenced by the captured web page are captured locally such that all references on the web page that originally pointed to remotely located objects now point to local objects. The agent then delivers the container to a repository.

Embodiments disclosed herein provide a performance displaying process that receives the container from the agent. The performance displaying process stores the container and displays the content of the captured web page within a graphical user interface. The performance displaying process provides information about the captured web page such as a test within the script on which the capture event occurred, the test time at which the capture event occurred, a server on which the agent was executing when the capture event occurred, an error code associated with the capture event, and an error name associated with the capture event. The performance displaying process also provides details related to the transaction performed on the web site by the script. As the script executes, various transactions are performed on the web site such as requesting a sequence of web pages. The performance displaying process provides a representation of the web pages requested by the script, including information regarding which web pages were successfully executed, which web pages had errors and which web pages were not accessed during the execution of the script. The performance displaying process also provides screen shots of the web pages requested by the script, including unaltered source code, HTTP headers, and trace route information.

Embodiments disclosed herein include a computer system executing an agent process. The agent obtains a script containing at least one transaction to be performed with the web site. The transaction defines a sequence of page requests identifying at least one web page to obtain from the web site. The agent executes the script to perform the transaction with the web site. Performance of the transaction includes retrieving the sequence of the web page. The agent detects a capture event associated with the web page. In response to the capture event, the agent captures content of the web page, and packages the content of the web page into a container capable of being rendered, such that the container provides a plurality of components associated with the captured web page. The agent then delivers the container to a repository.

Embodiments disclosed herein also include a computer system executing a performance displaying process that receives a container from the agent. The container contains at least one captured web page associated with a web site. The captured web page contains a plurality of components, and is a result of at least one transaction executed on the web site by the agent. The performance displaying process stores the container, and renders the container to display the content of the captured web page.

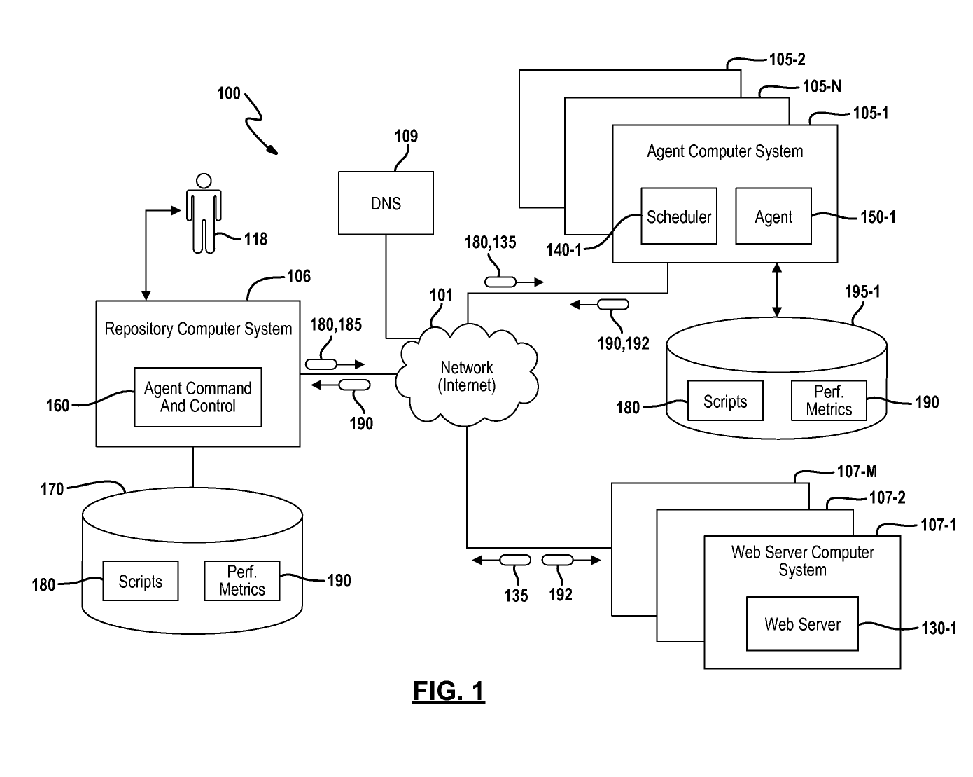

FIG. 1 illustrates a computer network environment 100 suitable for use in explaining example embodiments disclosed herein. The computer network environment 100 includes a computer network 101, such as the Internet, that couples a plurality of agent computer systems 105-1 through 105-N to a plurality of web server computer systems 107-1 through 107-M. The agent computer systems 105 each operate a respective scheduler 140 (there may be more than one) and one or more agents 150. The web server computer systems 107 each operate a respective web server 130. The agents 150 and web servers 130 may be software applications that execute on the respective computer systems 105 and 107. The network 101 also couples a repository computer system 108 that operates an agent command and control process 160 under guidance of an operator 118. The agent command and control process 160 maintains a repository 170 such as a database that stores scripts 180 to be executed by the agents 150 and performance metric data 190. The network 101 also includes one or more domain name server computer server systems 109 to operate according to the DNS protocol. The agent computer systems 105 may be located across a broad geographic area such as throughout the United States or throughout the entire world. This schedule 140 and agents 150 operate as autonomous software processes on the agent computer systems 105 and can be remotely controlled by the agent command and control process 160 as explained herein. The agent computer system 105 and the agent command and control process 160 may be referred to collectively herein as a performance management tool.

As noted in the summary above, the agents 150 are operable to obtain one or more scripts 180 from the agent command and control process 160. Each script defines one or more transactions that may be performed with one or more of the web servers 130 operating in the web server computer systems 107. As a brief example, the web servers 130 may be commercial web servers operated by business organizations that sell goods or services on the Internet. The business organizations may pay a fee to have a script 180 developed by the operator (e.g., the assignee of embodiments disclosed herein) to perform various transactions with the web servers 180, such as accessing a web page 135. The agent 150 issues a request 192 (e.g., an HTTP GET request) for the web page 135 to be served from the web site using the uniform resource locator specified in a page request. Once the operator 118 has created a script 180 and that encapsulated information associated with performance of the transaction with the web server 130, the agent command and control process 160 can propagate the script to the agent computer systems 105 for receipt by the scheduler 140. The scheduler 140 receives the script 180, and places in any script database that is local to the agent computer system 105. The scheduler 140 also receives scheduling information 185 from the agent command and control process 160 that indicates how frequently scheduler 140 should activate or execute the script 180 within an agent 150. In one configuration scheduling information 185 may be embedded within the script 180.

Upon occurrence of the time to execute the script 180, the scheduler 140 provides the script 180 from the script database 195 to the agent 150 for execution. The agent 150 is able to execute the transaction(s) defined within the script 180 in conjunction with the web server 130 to perform the scripted transaction on the web site of the business organization. During performance of the transaction, the agent 150 is able to collect detailed performance metrics 190 concerning all aspects of performance of the transaction with respect to each web involved in the transaction.

The traffic flow tracking process 170 may be embodied as software code such as data and/or logic instructions (e.g., code stored in the memory or on another computer readable medium such as a removable disk) that supports processing functionality according to different embodiments described herein.

It is noted that example configurations disclosed herein include the traffic flow tracking process 170 itself (i.e., in the form of un-executed or non-performing logic instructions and/or data). The traffic flow tracking process 170 may be stored as an application on a computer readable medium (each as a floppy disk), hard disk, electronic, magnetic, optical, or other computer readable medium. The traffic flow tracking process 170 may also be stored in a memory system such as in firmware, read only memory (ROM), or, as in this example, as executable code in, for example, Random Access Memory (RAM). Those skilled in the art will understand that the first router 110, the second router 120 and a collector 160 may include other processes and/or software and hardware components, such as an operating system not shown in this example.

One aspect of the performance management tool is configured to identify performance problems and determine a root cause for each of the identified problems in an automated manner. For example, response times and other performance metrics captured during synthetic testing can be evaluated to surface performance problems with the applications being monitored. A technique for identifying performance problems resulting from synthetic testing and determining a root cause for the identified problems is set forth below. It is readily understood that this technique can be extended to other types of performance data collected by the performance management tool 12.

In one embodiment, the data analysis function is initiated by an operator via a user interface of the performance management tool 12. For example, while viewing dashboards displaying various performance metrics, the user may notice a potential problem. The user would in turn initiate an automated process to identify any problems along with a root cause for each identified problem. To do so, the user may input a test identifier for a particular synthetic test of interest as well as a time frame for the data analysis. Although not limited thereto, a typical time frame might be two to four hours. This time frame is also referred to herein as the data analysis window.

In other embodiments, the data analysis function can be triggered automatically, for example, when a particular parameter exceeds an alert limit. For example, if the page response time for a particular web page exceeds a predefined alert limit, the data analysis function is automatically triggered. In this case, the test identifier may be retrieved from a corresponding test record and the data analysis window is set to a default time range.

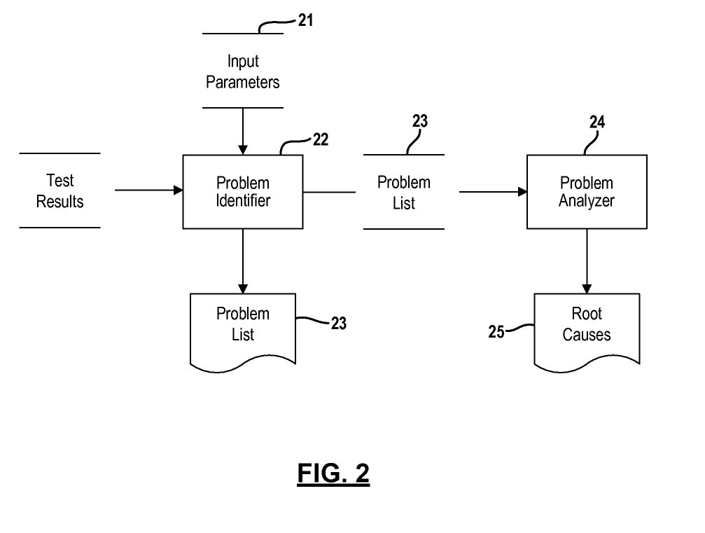

An overview of the data analysis function is depicted in FIG. 2. A problem identifier 22 is configured to receive the input parameters 21. In an example embodiment, the input parameters are an identifier for the synthetic test of interest along with a time frame for the data analysis window. The problem identifier 22 first operates to retrieve all of the performance metrics and any other raw data associated with the specified test and falling within the data analysis window. The problem identifier 22 then analyzes the data and generates a list of problems 23 as will be further described below. The list of problems 23 serves as an input to a problem analyzer 24. The list of problem 23 may also be communicated to the user of the performance management tool.

From the list of problems 23, the problem analyzer 24 determines a root cause for each of the identified problems as will be further described below. Likewise, the list of identified problems, along with an associated root causes for each problem (indicated as 25), is then communicated to the user of the performance management tool. The listing may be communicated, for example by sending an email notification with the listing to the user or presenting the listing on a display device. Other means of communicating the listing are also contemplated by this disclosure.

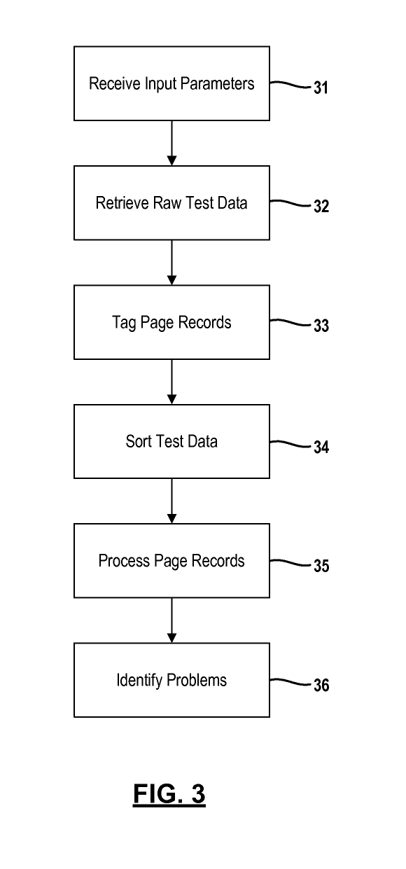

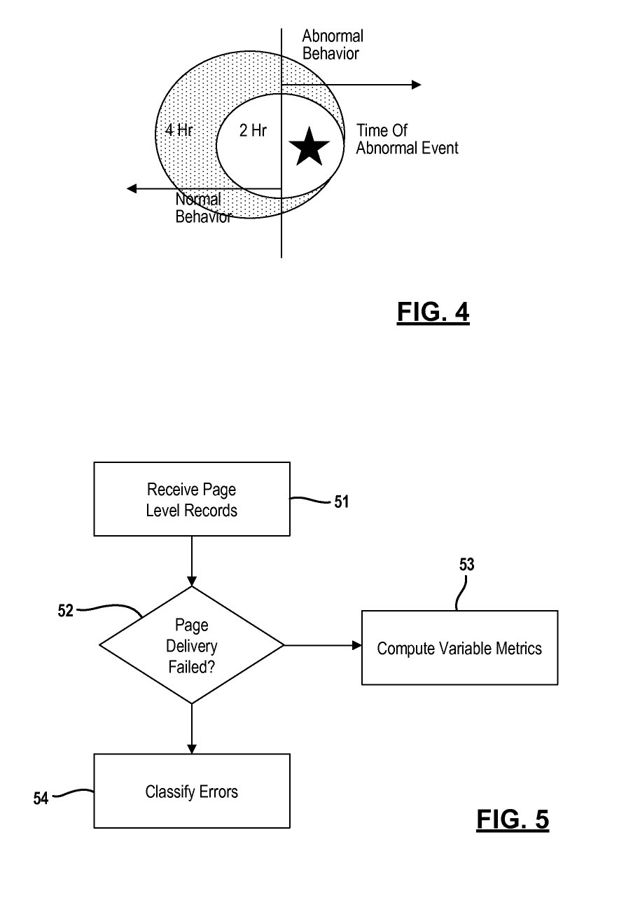

FIG. 3 further illustrates an example method for identifying performance problems which may be implemented by the problem identifier 22. Upon receipt of input parameters, raw performance data associated with a specified test is retrieved at 32. Data analysis is centered on data immediately surrounding a problematic event (i.e. spike in performance times, decrease in web page availability, abnormal increase in errors being reported, etc.). In an example embodiment, the problematic event is selected as an outlier data point by a user from a graphical representation of performance data. As depicted in FIG. 4, the problem identifier is configured to automatically gather detailed test results in a time period (e.g., 2-4 hour range) around a problematic point in time. This period of time is considered the data analysis window.

In the example embodiment, performance metrics captured during synthetic testing are compiled into test result records, where each record is tagged with an identifier for the test which generated the record. Test result records pertaining to a particular test can be retrieved using the test identifier specified in the input parameters. Example performance metrics may include but is not limited to total response time for loading a web page, total bytes of the loaded web page, total number of TCP connection used by the web page, the number of components included in the web page, a HTTP success or error code for the web page, DNS lookup time, TCP connection time, SSL negotiation time, number of bytes downloaded, and other non-HTTP standard errors. In the example embodiment, the test result records are stored in and retrieved from repository 170 or another database which has accumulated performance metrics from the various monitoring tools and is accessible to the problem analyzer 14.

During monitoring, test result records are generated at different levels. For example, numerous test result records are generated at a page level (i.e., pertaining to performance of a particular web page). When a web page is loaded, a test record may be generated indicating the total response time for the web page, another test record may be generated indicating the total bytes for the web page, and so forth. Similarly, numerous test result records are generated pertaining to the performance of the network connection over which each component of the web page was loaded. That is, a test record may be generated indicating the DNS lookup time for a loaded component, another test record may be generated indicating the TCP connection time for a loaded component, and so forth.

Additionally, test records are generated at a test level. For example, a test result record is generated each time a test is executed, where the test level record includes an indication of the test status (e.g., success, error, etc.). In preparation for data analysis, each page level test record is identified and tagged at 33 with the test status indicator from the corresponding test execution. Test result records may also be sorted and grouped as indicated 34. For example, test results records pertaining to content retrieval may be segmented from records pertaining to the network connection. Test result records at the page level are further processed at 35 before being used for problem identification at 36. It is readily understood that a particular test may be executed multiple times and/or at multiple network locations during a given data analysis window. It is to be understood that only the relevant steps of the methodology are discussed in relation to FIG. 3, but that other software-implemented instructions may be needed to implement the problem identifier 22.

Further processing of page level records is further described in relation to FIG. 5. Test result records pertaining to the loading of a web page and falling within the data analysis window are received at 51. Test result records are divided into successful and non-successful results. That is, a determination is made at 52 for each test result record as to whether the record pertains for a successful loading of a web page or an unsuccessful loading of a web page. This determination can be made from the status indicator appended to each page level record. Other techniques for determining whether a record pertains to a successful or unsuccessful page load are contemplated by this disclosure.

When a test result record is associated with a successful page load, additional metrics are computed at 53 for that particular web page. Specifically, a measure of variance is computed amongst values of a performance metric, where the performance metric pertains to the loading of the web page and an identifier for the particular web page is extracted from the test result record. In the example embodiment, variance measures are calculated for three different performance metrics: the size of the particular web page, the response time for loading the particular web page, or the count of object embedded in the particular web page. Other types of performance metrics fall within the broader aspect of this disclosure. Because a particular web page may be loaded numerous times during the data analysis window, a variance measure for the particular web site is computed from amongst all of the values for the performance metric during the data analysis window. Example variance measures include but are not limited to a minimum value, a maximum value, an average value and a standard deviation.

When a test result record is associated with an unsuccessful page load, the error associated with the test result record is classified at 54 into one of a predefined group of error types. Test result records associated with an unsuccessful page load contain an error code which can be associated with one of the error types. In the example embodiment, the predefined error types are defined as follows: server error, network error, redirection error, client error, DNS lookup error, timeout reached error, byte limit exceeded error, content mismatch error, user script error, test abort error and another ‘catch all’ category. Each error type can have one or more errors codes associated therewith. When the error code in a test result record corresponds to an error code associated with one of the error types, the test result record is classified as that error type. When the error code in the test result record does not match an error code in any one of the error types, the test result record is placed in the other category. It is envisioned that test result records may be classified into other error type groups.

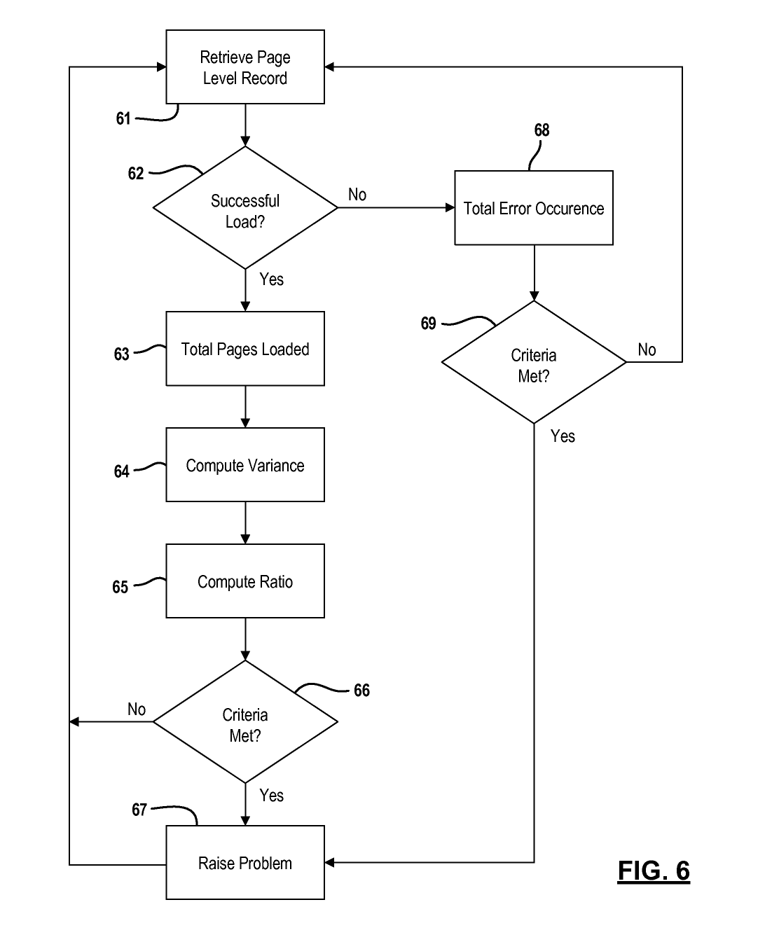

Rather than surface all problems, the most significant problems are identified and surfaced as shown in FIG. 6. Page level records are evaluated differently depending on whether the page was loaded successfully or not at indicated at 62. For pages successfully loaded, problems are raised when one or more variance measures exceed applicable thresholds. In an example embodiment, problems are raised upon meeting the following criteria. First, the occurrences that a particular web page was successfully loaded are totaled at 63. Second, a variance is computed at 64, for example by subtracting a minimum value for a given performance metric from a maximum value of the given performance metric. Third, a ratio is computed at 65 by dividing the minimum value of the given performance metric by the maximum value of the given performance metric. For a particular performance metric of a particular web page, a performance problem is raised at 67 when the number of occurrences of the particular web page loading successfully exceeds a first predefined threshold, the variance exceeds a second predefined threshold (e.g., one second) and the ratio exceeds a third predefined threshold (e.g., 100%). In some embodiments, first predefined threshold may vary depending on the size of the data analysis window. Certain problems are categorized as performance problems (e.g., page response time); whereas, other problems are categorized as page content problems (e.g., page size or object count metrics). In either case, the method set forth above may be used to evaluate different performance metric and surface the most significant problems.

For unsuccessfully loaded pages, problems are raised depending on the number of occurrences for a given error type. To do so, the occurrences of an error type are totaled at 68 and compared at 69 to a threshold. The threshold may be the same or vary between error types. A performance problem is then raised at 67 when the number of occurrences exceeds the threshold. This type of problem is categorized as an availability problem. This process may be repeated for each of the page level records.

Dynamic thresholds can also be used to identify and surface the most significant problems. In this alternative approach, page level records are first divided into two groups: records associated with successful page loads and records associated with unsuccessful page loads. Page level records may be clustered using a clustering algorithm, such as the K-means clustering algorithm. Statistical process control is then applied to compare the two clusters. For example, a variance for a particular performance metric (e.g., page size, page response time, etc.) between the two clusters is calculated to determine the significance of the differences. A problem is indicated when the variance is statistically significant enough. Sample size minimums may be applied to the number of records in each cluster before proceeding with statistical process control.

A particular example of a statistical process control is further described below. Given two clusters of performance measurements (bad and good), Y₁, . . . , Y_{N} and Z₁, . . . , Z_{N}, the basic statistics for the test are the sample means

$$\overline{Y} = \frac{1}{{N}_{1}} {\sum }_{i = 1}^{{N}_{1}} {Y}_{i} ; \overline{Z} = \frac{1}{{N}_{2 }} {\sum }_{i = 1}^{{N}_{2}} {Z}_{i}$$

and the sample standard deviations

$${s}_{1} = \sqrt{\frac{{\sum }_{i = 1}^{{N}_{1}} {( {Y}_{i} - \overline{Y} )}^{2}}{{N}_{1} - 1}}$$

$${s}_{2} = \sqrt{\frac{{\sum }_{i = 1}^{{N}_{2}} {( {Z}_{i} - \overline{Z} )}^{2}}{{N}_{2} - 1}}$$

with degrees of freedom v₁=N₁−1 and v₂=N₂−1 respectively. If it cannot be assumed that the standard deviations from the two processes are equivalent, the test statistic is

$$t = \frac{\overline{Y} - \overline{Z}}{\sqrt{\frac{{s}_{1}^{2}}{{N}_{1}} + \frac{{s}_{2}^{2}}{{N}_{2 }}}}$$

The combined degree of freedom is not known exactly but can be estimated using the Welch-Satterthwaite approximation

$$v = \frac{{( \frac{{s}_{1}^{2}}{{N}_{1}} + \frac{{s}_{2}^{2}}{{N}_{2 }} )}^{2}}{\frac{{s}_{1}^{4}}{{N}_{1}^{2} ( {N}_{1} - 1 )} + \frac{{s}_{2}^{4}}{{N}_{2}^{2} ( {N}_{2} - 1 )}}$$

The strategy for testing is to calculate the appropriate t statistic using the formulas above, and then perform a test at significance level α, where α is chosen to be small, typically 0.01, 0.05 or 0.10. Then decide the difference is significant if:

t≧t_{1·α,v}

The critical values from the t table depend on the significance level and the degrees of freedom in the standard deviation. When the difference is significant, the associated performance metric is raised as a problem. Other methods for evaluating the statistical significance of a variance also fall within the broader aspects of this disclosure.

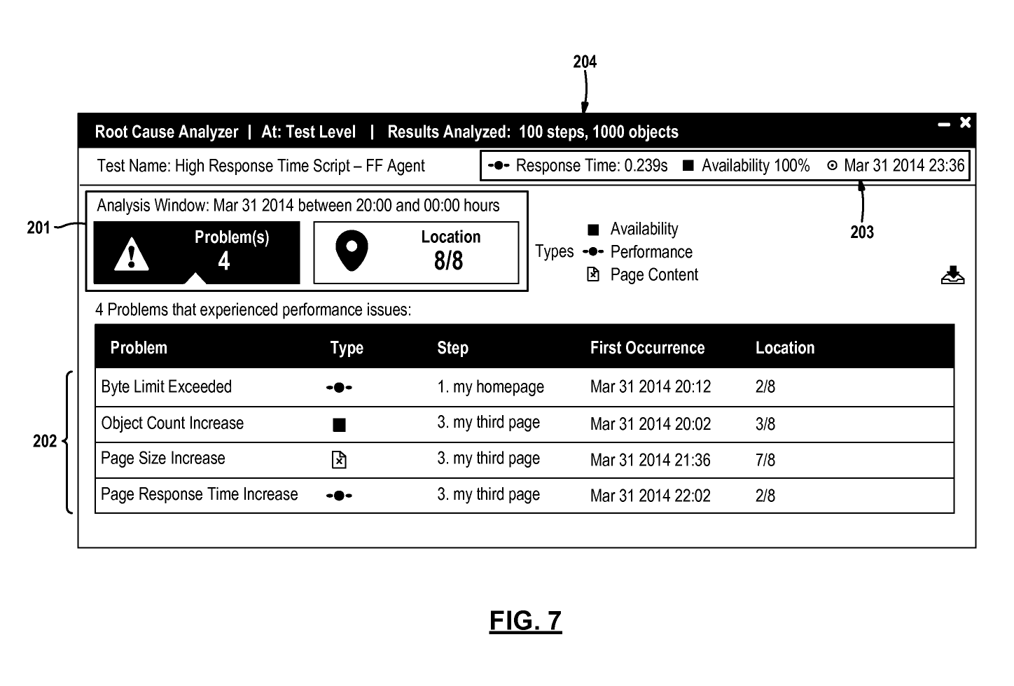

Problems raised may be stored in a data store for subsequent processing. In one embodiment, the list of raised problems may be presented to a user of the performance management tool. An example interface for presenting a listing of raised problems is illustrated in FIG. 7. In one embodiment, the interface includes an analysis window 201 along with a listing of problems 202. The analysis window 201 specifies the number of unique problems found and the number of test locations experiencing problems. Each problem in the listing may include a name or identifier for the problem, a first occurrence of the problem, as well as the number of test locations reporting this problem. The interface may further include the data point selected for analysis and the amount of data analyze as indicated at 203 and 204, respectively. Other types of data may also be presented with the listing of raised problems. In other embodiments, the listing of identified problems may be filtered in other ways or may include all of the identified problems.

Additionally, the listing of raised problems may be prioritized for the user so they can focus on the most impactful problems. An example ranking function is as follows. First, a weight value is assigned to each raised problem based on the problem category. By way of example, the availability category is assigned a weight of 0.5, the performance category is assigned a weight of 0.3 and the page content category is assigned a weight of 0.2. A ranking value is then computed for each raised problem. Because different factors impact each category, the different categories may employ different methods to compute a ranking value. For problems in the availability category, the rank value is computed in accordance with

rank value=error rate*portion of host IPs*portion of sites*weight factor

where error rate is the number of page loads with an error divided by the total number of page loads; portion of host Internet Providers (IPs) is the number of IPs with errors divided by the total number of IPs; and the portion of sites is the number of sites with an error divided by the total number of sites per page host. For problems in the performance category, the rank value is computed in accordance with

rank value=(1−exp(Coef_{—}A*increase))*portion of host IPs*portion of sites*portion of tests*weight factor

where increase is the page response time increase computed as a difference between the page response time maximum and the page response time minimum for each page host, root IP and site ID combination, and portion of tests is the number of page loads with problems divided by the total number of page loads. For problems in page content category, the rank value is computed in accordance with

rank value=(1−exp(Coef_{—}B*object increase))*(1−exp(Coef_{—}C*byte increase))*portion of host IPs*portion of sites*portion of tests*weight factor

where objects increase is a difference between maximum object count per page and the minimum object count per page over all successful page loads and byte increase is a difference between maximum byte count per page and minimum byte count per page over all successful page loads. Once a ranking value has been computed for each raised problem, the list of raised problems is sorted in descending order based on corresponding rank value. While an example ranking function has been set forth above, it is readily understood that different ranking functions fall with the broader aspects of this disclosure.

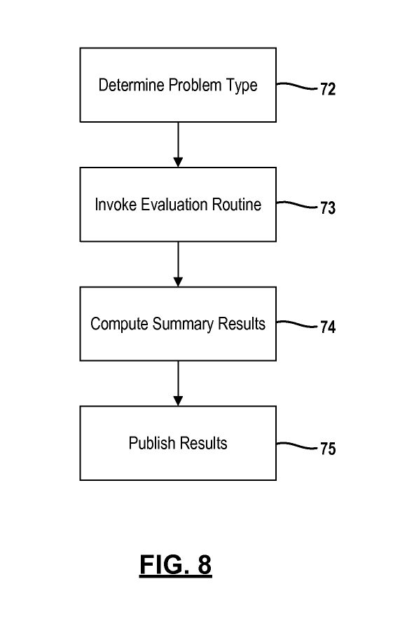

FIG. 8 depicts an example method for determining a root cause for each identified problem and may be implemented by the problem analyzer 24. In the example embodiment, the list of raised problems from the problem identifier 22 serves as input to the problem analyzer 24. For each raised problem, the problem type is determined at 72. A different evaluation routine is then invoked at 73 for the raised problem based on the problem type. For example, if the problem raised is of the type timeout error, then a routine for determining the root cause of a timeout error is invoked; whereas, if the problem raised is of the type byte limit exceeded, then a routine for determining the root cause of byte limit exceeded is invoked. Each evaluation routine makes a detailed determination as to the root cause of the problem.

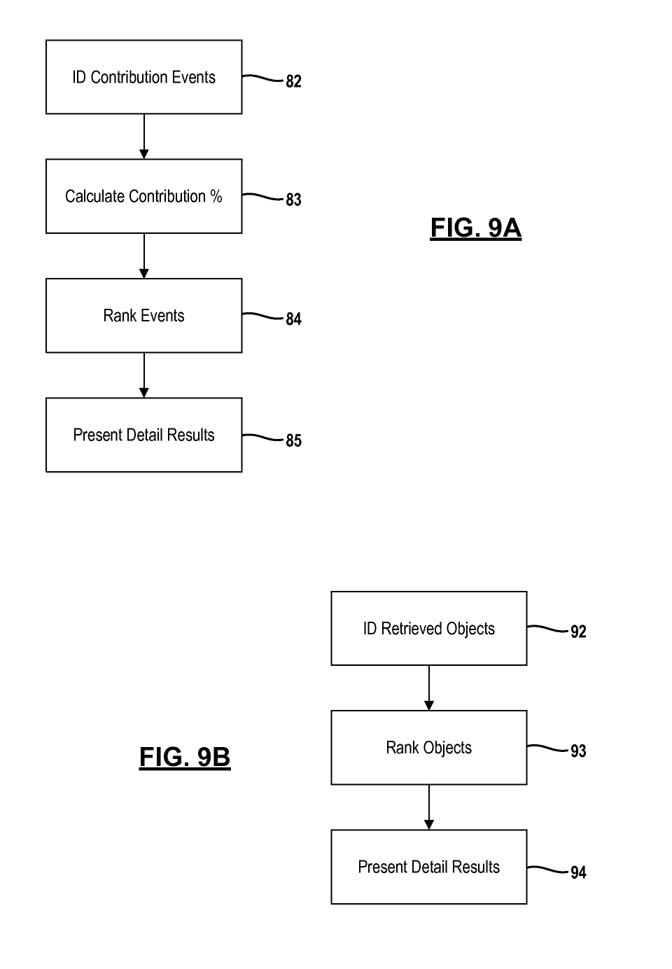

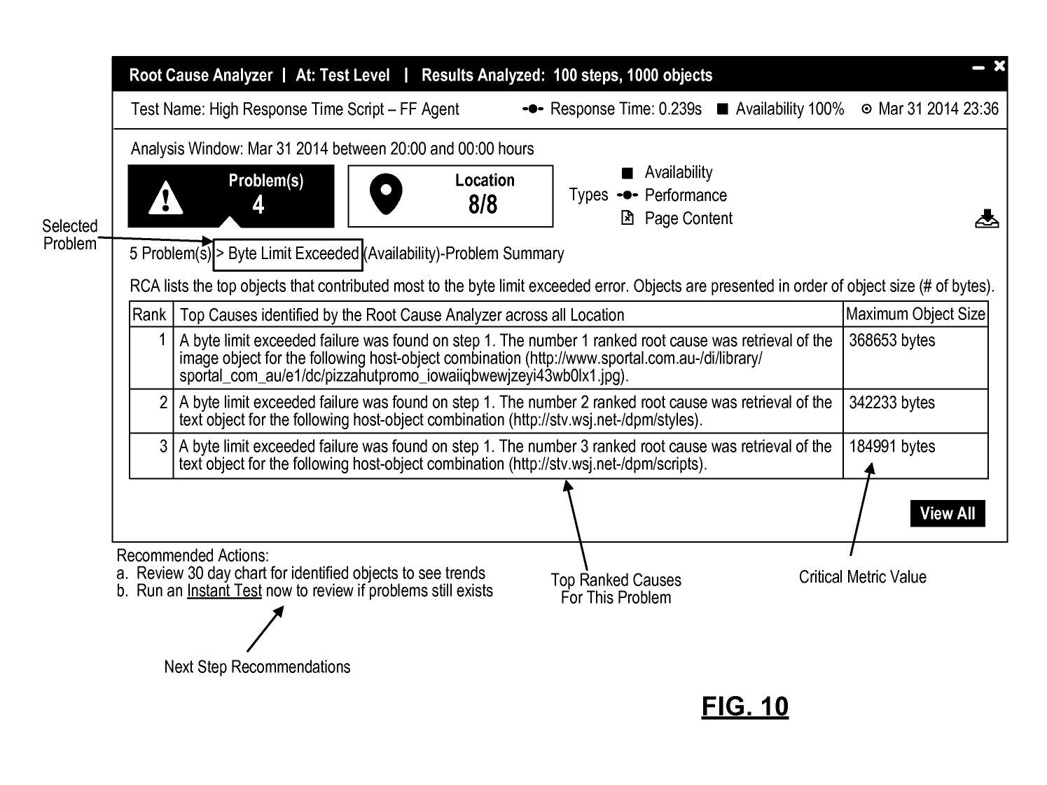

Timeout failures occur when the total test execution time for a page exceeds the maximum allowable time limit as set by the testing agent. The root cause analyzer routine for timeout failures lists the events (object retrieval or connection times) that contributed most to the timeout error. An example root cause analyzer routine for timeout failures is further described in relation to FIG. 9A.

Events that contributed to the overall page response time are identified first at 82. These events can be either object delivery related or connection related. Object delivery impacts are found in the raw object information (testbreakdown) and connection related impacts are found in the raw connection information (connbreakdown). A page contribution percentage is then calculated at 83 for each identified event. For object delivery events, the page contribution percentage is calculated by dividing the object's response time by the overall page response time. For connection events, the page contribution percentage is calculated by dividing the particular event time by the overall page response time. Page contribution percentages for all events are merged and then ranked at 84 for example in descending order. When combining the object delivery event and connection event results together, the identifier of the problem resource is calculated differently for objects delivery events and connection events. For the object delivery events, the problem resource identifier is a concatenation of urlhost field and url page field; the metric type is set to ‘obj_type’ and the metric time is the object's response time. For the connection events, the problem resource identifier is the urlhost field, the metric type identifier is set to ‘metrictype’ and the metric time is the connection break down time. The number of event results is then controlled by a presentation parameter (i.e., MaxPageErrorObj). In the example embodiment, the events having a rank less than the presentation parameter (i.e., page contribution rank <=MaxPageErrorObj) will be presented at 85 as detail results.

Byte limit exceeded failures occur when the overall size of retrieved objects for a page exceeds the allowable threshold as set by the testing agent. The root cause analyzer routine for byte limit exceeded lists the objects that contributed most to the byte limit exceeded error. With reference to FIG. 9B, an example root cause analyzer routine for byte limit exceeded problem is further described. Each object retrieved on the particular web page is first identified at 92. The identified objects are then ranked at 92 based on its size (i.e., number of bytes), for example in descending order. This listing highlights the objects with the largest contribution to the overall page size. The number of objects displayed in the detailed results is controlled by a presentation parameter (e.g., MaxPageErrorObj). In an example embodiment, the objects having a rank less than the presentation parameter (i.e., object size rank <=MaxPageErrorObj) will be presented at 94 as detail results. It is understood that the presentation parameter may vary amongst the different problem types.

A problem definition and a problem content result are presented in the appendix below for each of the different problem types noted above. For brevity, an exemplary evaluation routine is not presented for each problem type. From the information in the appendix, one skilled in the art could develop an exemplary evaluation routine for the particular problem type. While reference made been made to particular problem types, it is readily understood that the broader aspects of this disclosure encompasses other types of problem and corresponding evaluation routines.

With continued reference to FIG. 8, summary results may also be computed at 74 for each raised problem. Summary results are intended to identify the probable cause of a raised problem across multiple test locations. By way of example, detail results for timeout errors for a given web page are gathered from across multiple test locations. The top ranked items from each test location are extracted (e.g., page contribution rank <=MaxProbTopX) and a probability ranking for each unique problem resource reported across all of the test locations is determined using a probability formula, where the probability formula is sum of response times for a given problem resource divided by the sum of response times for all top ranked problem resources. The largest response time for each problem resource is also maintained. In the example embodiment, the number of objects displayed in the summary results is a predefined number of probable cause objects that have the highest probability ranking. The number of objects displayed may be controlled by a presentation parameter (i.e., object probability rank <=MaxPageErrorObj).

Summary results may be computed for byte limit exceeded failures in a similar manner. Details results for byte limit exceeded errors for a given web page are gathered from across multiple test locations. The top ranked items from each test location are extracted (e.g., object size rank <=MaxProbTopX) and a probability ranking for each unique object reported across all of the test locations is determined using a probability formula, where the probability formula is sum of bytes for a given object divided by the sum of bytes for all top ranked objects. The largest byte size for each unique object is also maintained. In the example embodiment, the number of results displayed in the summary results is a predefined number of probable cause objects that have the highest probability ranking. The number of objects displayed may be controlled by a presentation parameter (i.e., object probability rank <=MaxPageErrorObj).

Lastly, detail and/or summary results are published at 75 for each raised problem. In an example report, each raised problem is enumerated along with the detail results (i.e., listing of root causes) for the raised problem. Summary results for each raised problem may also be presented either additionally or alternatively. An example user interface presenting a listing of causes for a particular problem is depicted in FIG. 10. In this example, the top causes for the byte limit exceeded error across all locations are presented. In this way, the root cause analysis is completed in an automated manner and without a person having to determine where and how to get this level of information themselves.

In another aspect of this disclosure, recommended actions can be presented to the user along with the list of top causes as shown in FIG. 10. Recommended actions may be selected based on the problem type and/or the causes associated with the problem. For example, a historic trend line may be constructed for an identified object causing a byte limit exceeded error. This recommended action would help determine if the object size for the identified object has shown a steady increase in size leading up to the error or if it was a sudden size increase. In the case of network related errors, a trace route routine may be recommended. The source and target IP addresses (or host names) of a network connection could be used as input to the trace route routine. The resulting detailed network routing map could be used to identify abnormalities. From these examples, one can recognize other types of actions that can be recommended depending on the problem type. In some embodiments, one or more recommended actions are initiated automatically, for example upon selection of a particular problem from the listing shown in FIG. 7. In this case, the recommended actions are executed and any results can supplement the information presented in FIG. 10.

Another feature allows a user to verify the persistence of a problem. In many instances, the problems being analyzed have occurred in the past. Thus, the user may be presented with an option to run an instant test. In short, the applicable test or portions thereof are executed using the test identifier for the corresponding test which produced the performance data. Test results from the instant test are then compared to the listing of problems to determine if the problem still exists or no longer exists. This determination itself may be presented to the user. Alternatively, this additional information may be used to increase or decrease the ranking for particular problems in the listing of problems. For example, problems that persist can have their ranking increase; whereas, problems that no longer exist can have their ranking decreased. In some embodiments, the instance test may be initiated by the user or automatically.

In some embodiments, root causes across surfaced problems are prioritized by a root cause ranking function so users can focus on the most impactful problems and their causes. Input to the root cause ranking function is the list of ranked problems and the top x root causes for each problem. In an example embodiment, the ranking function is implemented by calculating a weight value for each root cause as follows:

Cause weight value=problem weight value*(x−(cause rank value)/x)*percent value/100

where the problem weight value is the rank weight for the problem associated with a given root cause, cause rank value is the rank value for the given root cause amongst the causes associated with the problem and the computation of the percent value depends on the type of problem. For causes related to performance problems, the percent value the contribution percentage of the problem to the page response time. For causes related to availability problems, the percent value is the percent of availability failures for this same type of error. For causes related to page structure change problems, the percent value is the contribution percentage of the problem to the object increase or page size increase. Given the computed weight value for each root cause, the root causes can be ordered in descending order using the cause weight value and presented by the performance management tool. It is envisioned that the most significant root causes are presented, i.e., x number of causes having the highest weight value or all causes having a weight value exceeding a predefined threshold.

Additionally, each root cause is associated with a particular service provider. To ascertain the impact of different service providers, root causes may be grouped by service provider and re-ordered within each grouping in descending order using the cause weight value. The re-ordered listing of root causes can also be presented by the performance management tool. It is again envisioned that the most significant service providers. In one example, weight values for each service provider are summed and x number of service provides having the highest summation of weight values are presented. While reference has been made to a particular technique for computing cause weight values, other techniques for computing such weights fall within the scope of this disclosure.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

### APPENDIX

| Problem Type | Problem Definition/Problem Content Result |
|---|---|
| Server Error | Server errors represent page failures that are |
| | attributed to a problem within the host provider server |
| | infrastructure. The action error code will provide the |
| | specific reason for the server failure. The root cause |
| | analyzer routine lists the top actions that were being |
| | processed by the test when the server error occurred. |
| | The failing actions are presented in order by their |
| | processing time. The return code will indicate the |
| | exact error that was observed for this action. |
| Test Abort | Page failures that resulted from an aborted test |
| | execution. The root cause analyzer lists the top |
| | actions that were being processed by the test when |
| | the test abort occurred. The failing actions are |
| | presented in order by their processing time. The |
| | return code will indicate the exact error that was |
| | observed for this action. |
| Network Error | Network Errors represent page failures resulting from |
| | an inability to establish a connection to a specific host |
| | provider or the inability to maintain that connection |
| | during the entire test execution. The action error code |
| | will provide the specific reason for the network related |
| | failure. The root cause analyzer lists the top actions |
| | that were being processed by the test when the |
| | network error occurred. The failing actions are |
| | presented in order by their processing time. The |
| | return code will indicate the exact error that was |
| | observed for this action. |
| Client Error | Client Errors represent problems with the page |
| | content loading once the connection to the host is |
| | established. The action error code will provide the |
| | specific reason for the client issue. The root cause |
| | analyzer lists the top actions that were being |
| | processed by the test when the client error occurred. |
| | The failing actions are presented in order by their |
| | processing time. The return code will indicate the |
| | exact error that was observed for this action. |
| DNS Lookup- | Page failures that are associated with the inability to |
| Error | resolve the providers server host name to an IP |
| | address in order to establish a connection to that |
| | host. The root cause analyzer lists the top actions |
| | that were being processed by the test when the dns |
| | lookup error occurred. The failing actions are |
| | presented in order by their processing time. The |
| | return code will indicate the exact error that was |
| | observed for this action. |
| Redirection Error | Redirection Errors represent page failures associated |
| | with the redirection of the original page object to an |
| | alternative location. The action error code will provide |
| | the specific reason for the redirection error. The root |
| | cause analyzer lists the top actions that were being |
| | processed by the test when the redirection error |
| | occurred. The failing actions are presented in order by |
| | their processing time. The return code will indicate the |
| | exact error that was observed for this action. |
| Content Wait- | A content wait timeout occurs when the page load |
| Timeout | process is waiting for the existence of an object in the |
| | results and the wait time exceeds the maximum |
| | allowable time limit as set by the testing agent. The |
| | root cause analyzer lists the test time of the latest test |
| | execution that resulted in a content wait timeout error. |
| | It also indicates if that test execution contained |
| | content errors on that page, or any previous page, |
| | and will list the page content errors that were |
| | observed. |
| Execution- | An execution timeout occurs when the total test |
| Timeout | execution time for a page load or object retrieval |
| | exceeds the maximum allowable time limit as set by |
| | the testing agent. The root cause analyzer lists the |
| | top actions (object retrieval or connection times) that |
| | contributed most to the timeout error. Actions are |
| | presented in order of page contribution percentage. |
| | Page contribution is calculated by dividing the action |
| | response time by the overall page response time. |
| Byte Limit- | Byte Limit exceeded failures occur when the overall |
| Exceeded | size of retrieved objects for a page exceeds the |
| | allowable threshold as set by the testing agent. The |
| | root cause analyzer lists the top objects that |
| | contributed most to the byte limit exceeded error. |
| | Objects are presented in order of object size (# of |
| | bytes). |
| Content- | Page failures that are triggered by the existence, or |
| Mismatch | lack thereof, of certain keywords or phrases in the |
| | page results. The root cause analyzer lists the test |
| | time of the latest test execution that resulted in a |
| | content mismatch error. The failed validation string is |
| | provided. It also indicates if that test execution |
| | contained content errors on that page, or any |
| | previous page, and will list the page content errors |
| | that were observed. |
| User Script Error | Page failures that are raised during the execution of |
| | the test script where the script could no longer |
| | perform the necessary actions required. The root |
| | cause analyzer lists lists the test time of the latest test |
| | execution that resulted in a user script error. It also |
| | indicates if that test execution contained content |
| | errors on that page, or any previous page, and will list |
| | the page content errors that were observed. |
| Page Response | The overall page response time variance (max − min) |
| Time Increase | for successful page runs has exceeded the minimum |
| | threshold that was established for problem |
| | identification. The root cause analyzer lists the top |
| | actions (object retrieval or connection times) that |
| | contributed most to the page response time increase. |
| | Actions are presented in order of page contribution |
| | percentage. Page contribution is calculated by |
| | dividing the action response time by the overall page |
| | response time. |
| Structure Change- | The overall page object count variance (max − min) |
| Object Count | for successful page runs has exceeded the minimum |
| | threshold that was established for problem |
| | identification. The root cause analyzer lists the top |
| | providers that contributed most to the page object |
| | count increase. Providers (hosts) are list in order of |
| | their increased object count contribution for |
| | successful tests run during the analysis window. |
| Structure Change- | The overall page object size variance (max − min) for |
| Page Size | successful page runs has exceeded the minimum |
| | threshold that was established for problem |
| | identification. The root cause analyzer lists the top |
| | providers that contributed most to the page size |
| | increase. Providers (hosts) are list in order of their |
| | increased object size contribution for successful tests |
| | run during the analysis window. |
| Uncategorized | Page failures that cannot be classified into our |
| Page Error | standard Availability categories. The error code will |
| | indicate the reason for the failure. The root cause |
| | analyzer lists the error return code for test failures |
| | that were not classified into any existing Availability |
| | error category. |

What is claimed is:

1. A computer-implemented method for determining a root cause of a performance problem experienced in a distributed computing environment, comprising:
receiving a plurality of test result records, where each of the test result records falls within a data analysis window and pertains to loading of a web page during execution of a test;
identifying one or more of the test result records which indicate an unsuccessful loading of the web page;
for each of the identified test result records, classifying an error associated with the identified test result record into one of a group of error types;
for each error category in the group of error types, totaling occurrences of the error type during the data analysis window;
raising an availability problem for a given error type when the number of occurrences for the given error type exceeds a threshold, where the availability problem has at least one performance metric indicative thereof;
determining one or more root causes for the availability problem; and
publishing the root causes for the identified type of problems.

2. The computer-implemented method of claim 1 further comprises
executing a test script in the distributed computing environment, where the execution of the test script causes one or more web pages and its subcomponents to be loaded;
determining performance metrics which pertain to loading of the web pages during execution of the test script; and
generating the plurality of test result records during execution of the test script.

3. The computer-implemented method of claim 1 further comprises re-executing the test script or a portion thereof subsequently to the step of raising an availability problem and thereby verifying persistence of the availability problem.

4. The computer-implemented method of claim 1 wherein the performance metrics are selected from a group comprised of: total response time for loading a web page, total bytes of the loaded web page, total number of TCP connections used by the web page, a number of components included in the web page, a HTTP success or error code for the web page, DNS lookup time, TCP connection time, SSL negotiation time, and a number of bytes downloaded for the web page.

5. The computer-implemented method of claim 1 further comprises classifying an error using an error code contained in the test result record, where one or more error codes are associated with each error type.

6. The computer-implemented method of claim 1 wherein the error types are selected from a group comprised of: server error, network error, redirection error, client error, DNS lookup error, timeout reached error, byte limit exceeded error, content mismatch error, user script error, and test aborted error.

7. The computer-implemented method of claim 1 further comprises ranking the raised availability errors and publishing the raised availability errors in accordance with the ranking.

8. The computer-implemented method of claim 4 where the ranking of the raised availability error correlates inversely with prevalence of the raised availability error across the computing environment.

9. The computer-implemented method of claim 1 wherein determining a root cause further comprises
identifying actions that contributed to the availability problem;
quantifying contribution of each identified action to the availability problem;
ordering the identified actions in accordance with the contribution of each identified action to the availability problem; and
selecting a subset of the identified actions to publish as the root causes for the availability problem.

10. The computer-implemented method of claim 6 wherein quantifying contribution of each identified action further comprises determining a performance metric association with the availability problem, determining a value for the performance metric associated with a given identified action, and computing a percentage for the performance metric for the given identified action in relation to an overall value of the performance metric for the availability problem.

11. The computer-implemented method of claim 1 further comprises ranking root causes across a plurality of raised availability problems and publishing the root causes in accordance with the ranking.

12. The computer-implemented method of claim 11 further comprises grouping root causes by a service provider associated with each root cause and ordering root causes within each grouping in accordance with the ranking.

13. A computer-implemented method for determining a root cause of a performance problem experienced in a distributed computing environment, comprising:
receiving a plurality of test result records, where each of the test result records fall within a data analysis window and pertain to loading of a web page during execution of a test;
identifying one or more of the test result records which indicate a successful loading of the web page;
identifying a particular web page from each of the identified test result records;
for each particular web page, computing a measure of variance amongst values of a performance metric, where the performance metric pertains to the loading of the web page;
raising a performance problem when the variance measure exceeds a threshold;
determining a root cause for the performance problem; and
publishing the root cause for the identified type of problem.

14. The computer-implemented method of claim 13 further comprises executing a test script in the distributed computing environment, where the execution of the test script causes one or more web pages to be loaded;
determining performance metrics which pertain to loading of the web pages during execution of the test script; and
generating the plurality of test result records during execution of the test script.

15. The computer-implemented method of claim 14 further comprises re-executing the test script or a portion thereof subsequently to the step of raising an availability problem and thereby verifying persistence of the availability problem.

16. The computer-implemented method of claim 13 wherein the performance metrics are selected from a group comprised of: total response time for loading a web page, total bytes of the loaded web page, total number of TCP connections used by the web page, a number of components included in the web page, a HTTP success or error code for the web page, DNS lookup time, TCP connection time, SSL negotiation time, and a number of bytes downloaded for the web page.

17. The computer-implemented method of claim 13 wherein the measure of variance is selected from a group comprised of a minimum value, a maximum value, an average value and a standard deviation.

18. The computer-implemented method of claim 17 further comprises
totaling occurrences the particular web page was successfully loaded;
computing a variance between a minimum value of the performance metric and a maximum value of the performance metric;
computing a ratio between the minimum value of the performance metric and the maximum value of the performance metric; and
raising a performance problem when the number of occurrence of the particular web page loading successfully exceeds a first threshold, the variance exceeds a second threshold and the ratio exceeds a third threshold.

19. The computer-implemented method of claim 18 wherein the where the performance metric is further defined as one of a size of the particular web page, a response time for loading the particular web page, or a count of object embedded in the particular web page.

20. The computer-implemented method of claim 10 wherein determining a root cause further comprises
identifying actions that contributed to the availability problem;
quantifying contribution of each identified action to the availability problem;
ordering the identified actions in accordance with the contribution of each identified action to the availability problem; and
selecting a subset of the identified actions to publish as the root causes for the availability problem.

21. The computer-implemented method of claim 20 wherein quantifying contribution of each identified action further comprises determining a performance metric association with the availability problem, determining a value for the performance metric associated with a given identified action, and computing a percentage for the performance metric for the given identified action in relation to an overall value of the performance metric for the availability problem.

22. The computer-implemented method of claim 13 further comprises ranking root causes across a plurality of raised availability problems and publishing the root causes in accordance with the ranking.

23. The computer-implemented method of claim 22 further comprises grouping root causes by a service provider associated with each root cause and ordering root causes within each grouping in accordance with the ranking.

24. A computer-implemented method for determining a root cause of a performance problem experienced in a distributed computing environment, comprising:
receiving a plurality of test result records, where each of the test result records falls within a data analysis window and pertains to loading of a web page during execution of a test;
identifying one or more of the test result records which indicate a successful loading of the web page;
identifying a particular web page from each of the identified test result records;
for each particular web page, computing a measure of variance amongst values of a performance metric, where the performance metric pertains to the loading of the web page;
raising a problem when the variance measure exceeds a threshold;
identifying one or more of the test result records which indicate an unsuccessful loading of the web page;
for each of the identified test result records, classifying an error associated with the identified test result record into one of a group of error types;
for each error category in the group of error types, totaling occurrences of the error type during the data analysis window;
raising a problem for a given error type when the number of occurrences for the given error type exceeds a threshold, where the availability problem has at least one performance metric indicative thereof;
identifying actions that contributed to each raised problem;
quantifying contribution of each identified action to a given raised problem;
ordering the identified actions in accordance with the contribution of each identified action to the given raised problem; and
selecting a subset of the identified actions to publish as the root causes for the given raised problem.
